(19) United States
(12) Patent Application Publication
(10) Pub. No.: US 2026/0367605 A1
(43) Pub. Date: Nov. 19, 2026

(54) CONTROL DEVICE FOR MACHINE TOOL

(71) Applicant: FANUC CORPORATION, Yamanashi (JP)

(72) Inventors: Yuutarou HORIKAWA, Yamanashi (JP); Masashi YASUDA, Yamanashi (JP); Iwao MAKINO, Yamanashi (JP); Makoto HAGA, Yamanashi (JP)

(73) Assignee: FANUC CORPORATION, Yamanashi (JP)

(21) Appl. No.: 19/145,880

(22) PCT Filed: Jan. 19, 2023
(86) PCT No.: PCT/JP2023/001598

§ 371 Date: Jul. 3, 2025

(51) Int. Cl. G05B 19/4093; B23Q 15/013; G05B 19/4063

(52) U.S. Cl. CPC G05B 19/40937; B23Q 15/013; G05B 19/4063; G05B 2219/49277

(57) ABSTRACT

With respect to this control device for a machine tool, provided is a feature whereby it is possible to set a suitable range for stopping oscillation when an index value indicative of a machining state has exceeded an upper limit value. A numerical control device 1 of a machine tool comprises: a machining state acquisition unit 12 that acquires an index value indicative of a machining state; a machining upper limit value acquisition unit 13 that acquires an upper limit value of the index value indicative of the machining state; a program command acquisition unit 14 that acquires command information about a machining program 100; and an oscillation motion execution determination unit 15 that determines whether to execute an oscillation motion for oscillating a cutting tool T and a workpiece relative to each other on the basis of the machining program 100. The oscillation motion execution determination unit 15 sets the oscillation stop range in the machining program 100 such that the oscillation motion is not executed at or after a location where the index value exceeds the upper limit value.

### TECHNICAL FIELD

The present disclosure relates to a control device for machine tool.

### BACKGROUND ART

Oscillation cutting for cutting a workpiece with a cutting tool while relatively oscillating the workpiece and the cutting tool has been known as a technique for avoiding poor machining and machine failure caused by chips that are continuously generated during a cutting process and cling to the workpiece and the cutting tool.

If index values indicating a machining status of the oscillation machining of this type such as a feeding speed, an oscillation frequency, and an oscillation amplitude exceed preset upper limit values, correction may be made to the index values. However, the correction of the values related to the machining may not guarantee the safety of the machine due to resonance, or the corrected values may not meet the recommended machining conditions, resulting in a poor machined surface.

As a solution to these issues, there has been known a technique of determining whether the oscillation is required or not when the index values indicating the machining status exceed the preset upper limit values (see, e.g., Patent Documents 1 and 2).

### CITATION LIST

### Patent Document

Patent Document 1: Japanese Unexamined Patent Application, Publication No. 2021-114329
Patent Document 2: Japanese Unexamined Patent Application, Publication No. 2020-144588

### DISCLOSURE OF THE INVENTION

### Problems to be Solved by the Invention

The above-described technique determines whether the oscillation is required for different machining blocks. In some cases, however, the oscillation beyond the range of the machining block may not be required in view of influence on the surface to be machined, or the machining with oscillation may be required until the index value exceeds the upper limit value. The existing techniques still have room for improvement in terms of specification of the range where the oscillation is performed depending on the actual situation.

The present disclosure has been made to address the above-described challenges, and provides a technique that allows a control device for a machine tool to suitably set a range without oscillation if the index value indicating the machining status exceeds the upper limit value.

### Means for Solving the Problems

The present disclosure is directed to a control device for a machine tool that machines a workpiece while relatively oscillating a cutting tool and the workpiece. The control device includes: a machining status acquisition unit that acquires an index value indicating a machining status; a machining upper limit acquisition unit that acquires an upper limit value of the index value indicating the machining status; a program command acquisition unit that acquires command information of the machining program; and an oscillation motion determination unit that determines whether an oscillation motion of relatively oscillating the cutting tool and the workpiece is performed based the machining program, wherein the oscillation motion determination unit sets a range without oscillation so that the oscillation motion is not performed in part of the machining program subsequent to a point where the index value exceeds the upper limit value.

The present disclosure is further directed to a control device for a machine tool that machines a workpiece while relatively oscillating a cutting tool and the workpiece. The control device includes: a machining status acquisition unit that acquires an index value indicating a machining status; a machining upper limit acquisition unit that acquires an upper limit value of the index value indicating the machining status; a program command acquisition unit that acquires command information of the machining program; and an oscillation motion determination unit that determines whether an oscillation motion of relatively oscillating the cutting tool and the workpiece is performed based the machining program, wherein the oscillation motion determination unit sets a range without oscillation so that the oscillation motion is not performed in the whole machining program including a plurality of machining blocks in a case where there is a point where the index value exceeds the upper limit value in the machining program.

### Effects of the Invention

The present disclosure provides a technique that allows a control device for a machine tool to suitably set a range without oscillation if an index value indicating a machining status exceeds an upper limit value.

### BRIEF DESCRIPTION OF THE DRAWINGS

FIG. 1 is a view illustrating oscillation cutting;

FIG. 2 is a functional block diagram illustrating a control device for a machine tool according to a first embodiment of the present invention;

FIG. 3 is a functional block diagram of a machining status acquisition unit;

FIG. 4 is a graph illustrating the maximum distance between cutting paths;

FIG. 5 is a view illustrating examples of index values calculated by a machining status acquisition unit;

FIG. 6 is a view illustrating examples of upper limit values acquired by a machining upper limit acquisition unit;

FIG. 7 is a view illustrating a first example of a range without an oscillation motion determined by an oscillation motion determination unit of the first embodiment;

FIG. 8 is a view illustrating a second example of the range without the oscillation motion determined by the oscillation motion determination unit of the first embodiment;

FIG. 9 is a flowchart illustrating an example of a flow of an oscillation determination process by a numerical controller for a machine tool;

FIG. 10 is a view schematically illustrating an example of a range without an oscillation motion determined by an oscillation motion determination unit of a second embodiment; and

FIG. 11 is a functional block diagram illustrating a control device for a machine tool according to a variation of the present invention.

### PREFERRED MODE FOR CARRYING OUT THE INVENTION

Embodiments of the present disclosure will be described below with reference to the drawings. In the second and subsequent embodiments, the same components as those described in the first embodiment are indicated by the same reference numerals and are not described in detail.

### First Embodiment

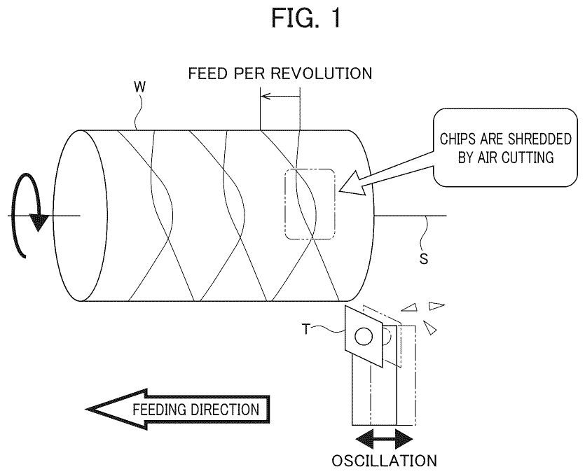

A numerical controller 1 for a machine tool according to a first embodiment of the present invention controls a machine tool that machines a workpiece W while relatively oscillating a cutting tool T and the workpiece W. Oscillation cutting will be described first with reference to FIG. 1.

FIG. 1 is a view illustrating the oscillation cutting. In an example of the oscillation cutting shown in FIG. 1, at least one main shaft S that allows the cutting tool T and the workpiece W to rotate relative to each other and at least one feed shaft (not shown) that allows the cutting tool T to move relative to the workpiece W are operated to allow the cutting tool T and the workpiece W to rotate relative to each other, and the workpiece W is cut while the cutting tool T and the workpiece W are relatively oscillating in a feeding direction. A tool path, which is a path of the cutting tool T, is set so that a current path partially overlaps with the previous path. Specifically, the current path includes part of the workpiece W already machined in the previous path. This causes air cutting, that is, the edge of the cutting tool T leaves the surface of the workpiece W, and chips are shredded.

The oscillation cutting performed in the present embodiment can be applied to workpieces of any shape. That is, the oscillation cutting is applicable to a workpiece that has a tapered or arc-shaped target surface and requires two or more feed shafts (Z shaft and X shaft) or a cylindrical or tubular workpiece that requires only a single specific shaft (Z shaft).

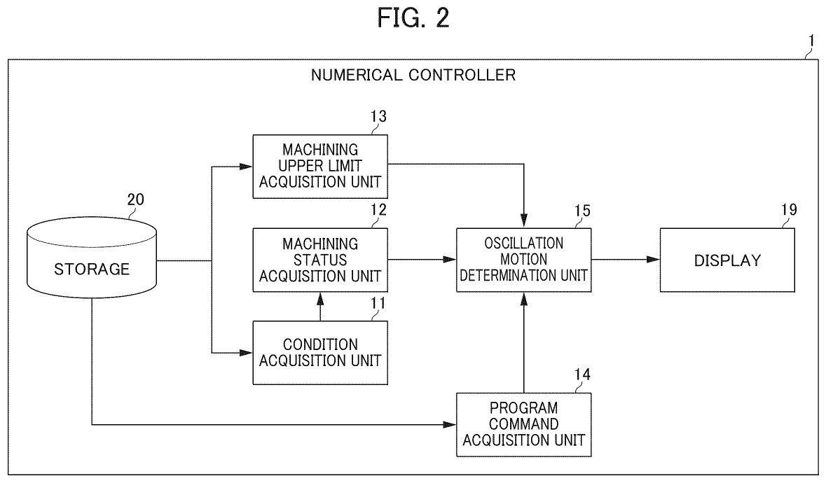

The configuration of the numerical controller 1 for the machine tool will be described below. FIG. 2 is a functional block diagram illustrating the numerical controller 1 for the machine tool according to the embodiment of the present invention. The numerical controller 1 for the machine tool of the present embodiment is constituted of, for example, memory such as read only memory (ROM) and random access memory (RAN) connected to each other via a bus, a control processing unit (CPU), and a computer including a communication controller. The functions and operations of functional units described later are achieved by cooperation of the CPU mounted on the computer, the memory, and a control program stored in the memory. The numerical controller 1 for the machine tool may be constituted of a computer numerical controller (CNC) or a programmable logic controller (PLC), or may be connected to a host computer that outputs a machining program and machining conditions such as a rotation speed.

As shown in FIG. 2, the numerical controller 1 for the machine tool includes, as the functional units, a condition acquisition unit 11, a machining status acquisition unit 12, a machining upper limit acquisition unit 13, a program command acquisition unit 14, an oscillation motion determination unit 15, and a storage 20.

The condition acquisition unit 11 acquires a machining condition and an oscillation condition. The machining condition and the oscillation condition are stored, for example, in the storage 20 as setting parameters for the machining program and the machine tool. The condition acquisition unit 11 may acquire the machining condition and the oscillation condition from an external storage of the numerical controller 1 or an external computer.

Examples of the machining condition include at least information on a feed per relative rotation of the cutting tool and the workpiece and information on the shape of the edge of the cutting tool, and also include other information such as a rotation number of the main shaft S (1/min), a feeding speed of the cutting tool (mm/min), a workpiece diameter (mm), and a clearance angle of the cutting tool (°). The information on the feed per relative rotation of the cutting tool and the workpiece may be a feed per revolution F (mm/rev), and the information on the shape of the edge of the cutting tool may be a nose radius of the edge R (mm).

Examples of the oscillation condition include information on the number of oscillations per relative rotation of the cutting tool and the workpiece and information on an oscillation amplitude relative to the feed per relative rotation of the cutting tool and the workpiece. The information on the number of oscillations per relative rotation of the cutting tool and the workpiece may be information on an oscillation frequency magnification I (times) indicating the oscillation frequency per rotation of the main shaft. The information on the oscillation amplitude relative to the feed per relative rotation of the cutting tool and the workpiece may be information on an oscillation amplitude magnification K (times) indicating the oscillation amplitude relative to the feed per rotation of the main shaft. The oscillation frequency magnification I (times) may be directly specified or may be calculated from the specified oscillation frequency (Hz) and the rotation number of the main shaft S (1/min). Likewise, the oscillation amplitude magnification I (times) may be directly specified or may be calculated from the specified oscillation amplitude (Hz) and the rotation number of the main shaft S (1/min).

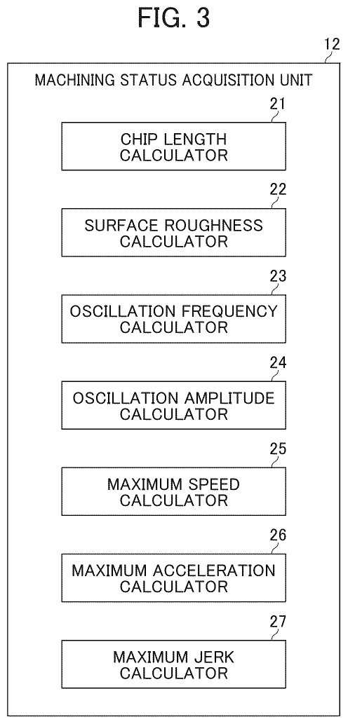

The machining status acquisition unit 12 calculates an index value indicating the machining status based on the machining condition and the oscillation condition inputted from the condition acquisition unit 11. Examples of the index value calculated by the machining status acquisition unit 12 will be described below with reference to FIG. 3. FIG. 3 shows a functional block diagram of the machining status acquisition unit. An example of how the machining status acquisition unit 12 performs determination and calculation will be described below.

In the formulae used as needed in the following description, Y represents a coordinate value (mm) in the feeding direction, f represents a feed per revolution of the main shaft F (mm/rev), S represents the rotation number of the main shaft (1/min), t represents time (sec), I represents the oscillation frequency magnification (times), K represents the oscillation amplitude magnification (times), r represents a workpiece diameter (mm) which is the radius of the workpiece W, R represents the shape of the edge such as a nose radius (mm), and h represents the maximum height Rz (μm) which is an index of surface roughness.

As shown in FIG. 3, the machining status acquisition unit 12 includes a chip length calculator 21, a surface roughness calculator 22, an oscillation frequency calculator 23, an oscillation amplitude calculator 24, a maximum speed calculator 25, a maximum acceleration calculator 26, and a maximum jerk calculator 27.

The chip length calculator 21 calculates the length of a chip from the workpiece W as the index value based on the machining condition and the oscillation condition. The machining condition used to calculate the chip length is, for example, the workpiece diameter (mm) which is the radius of the workpiece W. The oscillation condition used to calculate the chip length is, for example, the oscillation frequency magnification I (times) indicating the oscillation frequency per rotation of the main shaft. The chip length calculator 21 calculates the chip length using the following formula (1).

$$[ Formula 1 ]$$

$$\frac{2 π r}{I} \qquad Formula ( 1 )$$

The surface roughness calculator 22 calculates the surface roughness of the workpiece W as the index value based on the machining condition and the oscillation condition. The machining condition used to calculate the surface roughness is, for example, the feed per revolution of the main shaft F (mm/rev) and the nose radius R (mm) which represents the shape of the edge of the cutting tool T. The oscillation condition used to calculate the surface roughness is, for example, the oscillation frequency magnification I (times) indicating the oscillation frequency per rotation of the main shaft and the oscillation amplitude magnification K (times) indicating the magnitude of the oscillation amplitude relative to the feed per revolution of the main shaft.

The surface roughness calculated by the surface roughness calculator 22 includes, for example, at least one of arithmetic mean roughness, the maximum height which is the distance between the highest peak and the lowest valley, the maximum profile peak height which is the largest peak height from a mean line of a surface, the maximum profile valley depth which is an absolute value of the largest profile valley depth from the mean line of the surface, a mean height which is a mean value of the heights of profile elements that are sets of a peak and an adjacent valley, the maximum height of profile which is the sum of the largest peak height and the largest valley depth among the profile elements, and a material ratio which is the ratio of a material length of the profile elements to the evaluation length for a given section height level (% or μm).

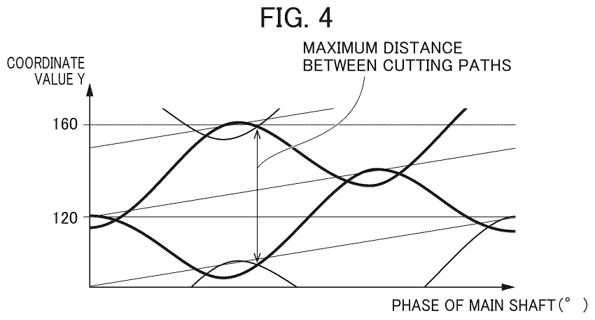

An example of how the surface roughness calculator 22 calculates the maximum height Rz as the surface roughness will be described below. FIG. 4 is a graph illustrating the maximum distance between cutting paths. FIG. 4 shows the point where the distance between the cutting paths is the maximum. In the present embodiment, coordinates Y of the point of the maximum distance between the cutting paths are obtained by the following formula (2), and a distance between the obtained coordinates is regarded as the maximum distance between the cutting paths. When calculating the maximum height Rz indicating the distance between the highest peak and the lowest valley as the surface roughness, for example, h is calculated as the maximum height Rz by using the nose radius R (mm) of the edge and the obtained maximum distance between the cutting paths substituted for f (distance) in the formula (3).

$$[ Formula 2 ]$$

$$Y = \frac{fS}{60} t + \frac{Kf}{2} \{ cos ( 2 π \frac{SI}{60} t ) - 1 \} \qquad Formula ( 2 )$$

$$[ Formula 3 ]$$

$$h = \frac{{f}^{2}}{8 R} \times 1000 \qquad Formula ( 3 )$$

As described above, the surface roughness is not limited to the maximum height Rz. The surface roughness may be, for example, arithmetic mean roughness Ra.

The oscillation frequency calculator 23 calculates the oscillation frequency of the relative oscillation of the cutting tool T and the workpiece W as the index value based on the machining condition and the oscillation condition. The machining condition used to calculate the oscillation frequency is, for example, the rotation number of the main shaft S (1/min). The oscillation condition used to calculate the oscillation frequency is, for example, the oscillation frequency magnification I (times) indicating the oscillation frequency per rotation of the main shaft. The oscillation frequency calculator 23 calculates the oscillation frequency using the following formula (4).

[Formula 4]

S [min⁻¹]/60×I Formula (4)

The oscillation amplitude calculator 24 calculates the oscillation amplitude of the relative oscillation of the cutting tool T and the workpiece W as the index value based on the machining condition and the oscillation condition. The machining condition used to calculate the oscillation amplitude is, for example, the feed per revolution F (mm/rev). The oscillation condition used to calculate the oscillation amplitude is, for example, the oscillation amplitude magnification K (times) indicating the magnitude of the oscillation amplitude relative to the feed per rotation of the main shaft. The oscillation amplitude calculator 24 calculates the oscillation amplitude using the following formula (5).

[Formula 5]

f×K Formula (5)

The maximum speed calculator 25 calculates the maximum speed of the relative oscillation of the cutting tool T and the workpiece W as the index value based on the machining condition and the oscillation condition. The machining condition used to calculate the maximum speed is, for example, the rotation number of the main shaft S (1/min) and the feed per revolution F (mm/rev). The oscillation condition used to calculate the maximum speed is, for example, the oscillation amplitude magnification K (times) indicating the magnitude of the oscillation amplitude relative to the feed per revolution of the main shaft and the oscillation frequency magnification I (times) indicating the oscillation frequency per rotation of the main shaft. The maximum speed calculator 25 calculates the maximum speed using the following formula (6).

$$[ Formula 6 ]$$

$$\frac{FS}{60} \vert KI - 1 \vert \qquad Formula ( 6 )$$

The maximum acceleration calculator 26 calculates the maximum acceleration of the relative oscillation of the cutting tool T and the workpiece W as the index value based on the machining condition and the oscillation condition. The machining condition used to calculate the maximum acceleration is, for example, the rotation number of the main shaft S (1/min) and the feed per revolution F (mm/rev). The oscillation condition used to calculate the maximum acceleration is, for example, the oscillation amplitude magnification K (times) indicating the magnitude of the oscillation amplitude relative to the feed per rotation of the main shaft and the oscillation frequency magnification I (times) indicating the oscillation frequency per rotation of the main shaft. The maximum acceleration calculator 26 calculates the maximum acceleration using the following formula (7).

$$[ Formula 7 ]$$

$$\frac{Kf}{2} \times {( π \frac{SI}{60} )}^{2} \qquad Formula ( 7 )$$

The maximum jerk calculator 27 calculates the maximum jerk of the relative oscillation of the cutting tool T and the workpiece W as the index value based on the machining condition and the oscillation condition. The machining condition used to calculate the maximum jerk is, for example, the rotation number of the main shaft S (1/min) and the feed per revolution F (mm/rev). The oscillation condition used to calculate the maximum acceleration is, for example, the oscillation amplitude magnification K (times) indicating the magnitude of the oscillation amplitude relative to the feed per rotation of the main shaft and the oscillation frequency magnification I (times) indicating the oscillation frequency per rotation of the main shaft. The maximum jerk calculator 27 calculates the maximum jerk using the following formula (8).

$$[ Formula 8 ]$$

$$4 KF \times {( π \frac{SI}{60} )}^{3} \qquad Formula ( 8 )$$

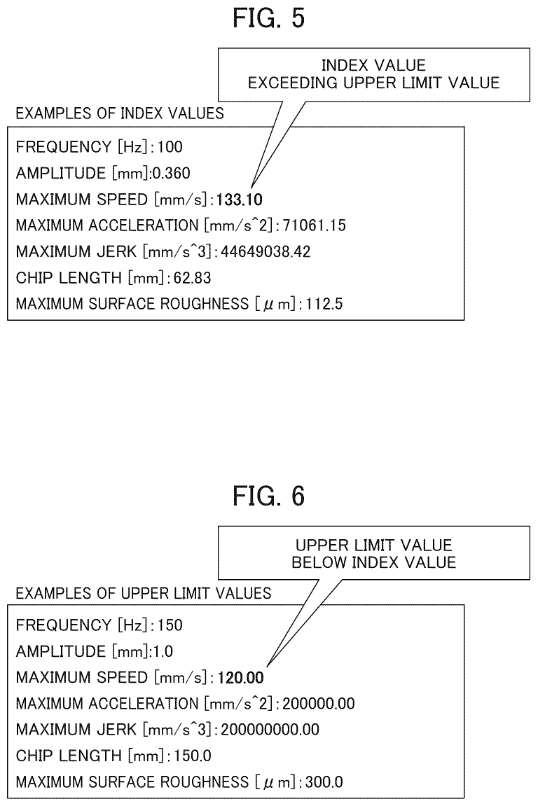

The functional blocks of the machining status acquisition unit 12 have been described. The machining status acquisition unit 12 calculates various types of index values using the functional blocks. FIG. 5 is a view illustrating examples of the index values calculated by the machining status acquisition unit 12. The machining status acquisition unit 12 preferably calculates one or more of the index values described above in any combination.

In the example shown in FIG. 5, a feeding speed F of 0.3 (mm/rev) and a rotation number of the main shaft S of 4,000 (rpm) are acquired as the machining conditions for a target machining block, and an oscillation frequency magnification I of 1.5 and an oscillation amplitude magnification K of 1.2 are acquired as the oscillation conditions. In this case, the machining status acquisition unit 12 calculates, as the index values, an oscillation frequency of 100 (Hz), an oscillation amplitude of 0.360 (mm), a maximum speed of 133.10 (mm/s), a maximum acceleration of 71061.15 (mm/s²), a maximum jerk of 44649038.42 (mm/s³), a chip length of 62.83 (mm), and a maximum surface roughness of 112.5 (μm).

The configuration of the machining status acquisition unit 12 have been described. The calculation of the index values described above is merely an example, and the index values of the machining status can be calculated by a method different from the method using the formulae.

The machining upper limit acquisition unit 13 will be described below. The machining upper limit acquisition unit 13 sets the upper limit values of the index values from preset setting parameters.

FIG. 6 is a view illustrating examples of the upper limit values acquired by the machining upper limit acquisition unit 13. In this example, the machining upper limit acquisition unit 13 acquires an oscillation frequency of 150 (Hz), an oscillation amplitude of 1.0 (mm), a maximum speed of 120.00 (mm/s), a maximum acceleration of 200000.00 (mm/s²), a maximum jerk of 200000000.00 (mm/s³), a chip length of 150.0 (mm), and a maximum surface roughness of 300.0 (μm) as the upper limit values.

The program command acquisition unit 14 will be described below. The program command acquisition unit 14 acquires command information of the machining program. The command information of the machining program includes information for specifying the point of the index value indicating the machining status. For example, when the machining program includes a plurality of machining blocks, the command information includes information that specifies the machining block associated with the index value and information that specifies the point of the index value in the machining block.

The oscillation motion determination unit 15 will be described below. The oscillation motion determination unit 15 determines whether the oscillation is performed or not based on the index value indicating the machining status and the upper limit value corresponding to the index value. The determination by the oscillation motion determination unit 15 may be performed before the machining starts or successively during the machining in real time.

In comparison between the index values shown in FIG. 5 and the upper limit values shown in FIG. 6, only the maximum speed of 133.10 (mm/s) exceeds the upper limit maximum speed of 120.00 (mm/s). This indicates that the oscillation should not be performed during the machining including this index value.

If any index value exceeds the upper limit value, the oscillation motion determination unit 15 determines a range without the oscillation motion based on the command information of the machining program. The range without the oscillation motion is suitably specified for each machining block or unit cutting section.

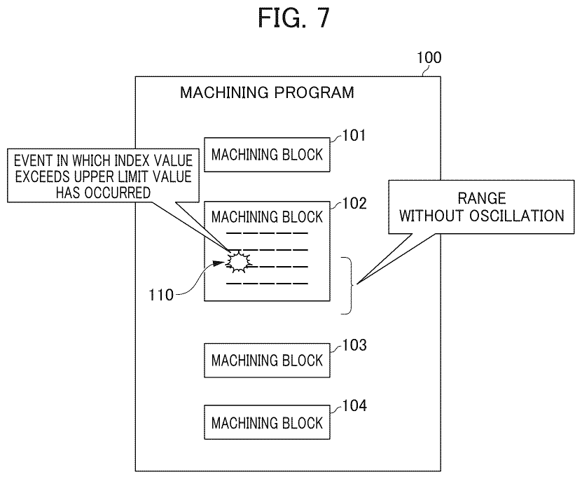

Referring to FIG. 7, a first example of the range without the oscillation motion according to the first embodiment will be described below. FIG. 7 is a view schematically illustrating the first example of the range without the oscillation motion determined by the oscillation motion determination unit 15 of the first embodiment.

FIG. 7 schematically shows an example of a machining program 100 including machining blocks 101 to 104. The actual machining is performed in accordance with commands of the machining blocks 101, 102, 103, and 104 in this order. In this example, it is supposed that an event has occurred in which any of the index values in the command of the machining block 102 exceeds the corresponding upper limit value (a point 110 at which the index value exceeds the upper limit value).

In the first example, part of the same machining block 102 subsequent to the point 110 at which the index value exceeds the upper limit value is set as the range without the oscillation motion. Thus, the oscillation motion is performed in part of the same machining block 102 preceding the point 110 at which the index value exceeds the upper limit value. The oscillation motion is also performed in the other machining blocks 101, 103, and 104 than the machining block 102.

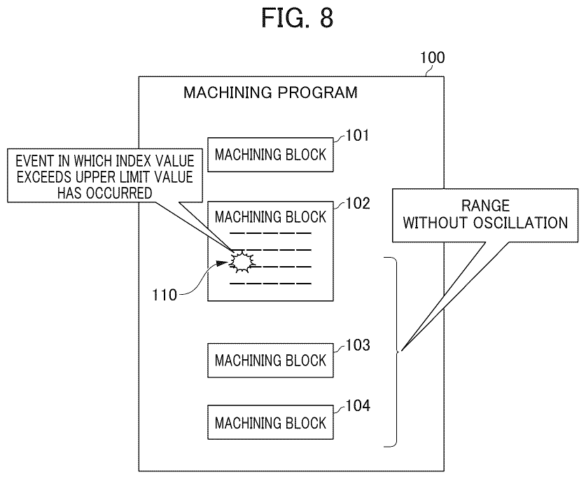

Referring to FIG. 8, a second example of the range without the oscillation motion according to the first embodiment will be described below. FIG. 8 is a view schematically illustrating the second example of the range without the oscillation motion determined by the oscillation motion determination unit 15 of the first embodiment.

In FIG. 8, the machining program 100, the machining blocks 101 to 104, and the event in which any of the index values exceeds the corresponding upper limit value (the point 110 at which the index value exceeds the upper limit value) are the same as those shown in FIG. 7.

In the second example, in addition to the part of the machining block 102 subsequent to the point 110 at which the index value exceeds the upper limit value, the machining blocks 103 and 104 are also set as the range without the oscillation motion. That is, the oscillation motion is not performed in the machining blocks 102 to 104. In the machining block 101, which is prior to the event in which the index value exceeds the corresponding upper limit value (the point 110 at which the index value exceeds the upper limit value), the oscillation motion is performed if the oscillation condition is set.

The range without the oscillation motion is not limited to those of the first and second examples. For example, the machining block 103 next to the machining block 102 where an event in which any of the index values exceeds the corresponding upper limit value has occurred can be set as the range without the oscillation motion. This can avoid sudden change of control during real time processing, allowing more stable machining.

Suitably specifying the range without the oscillation motion allows the control device to accommodate to constant surface speed control and spindle override.

The constant surface speed control rotates the main shaft faster if the workpiece diameter is small or slower if the workpiece diameter is large, so that the workpiece W is cut at the same relative speed. Under the constant surface speed control, the speed of the main shaft may possibly increase beyond the upper limit value due to the decreasing diameter of the workpiece W in the course of the machining. According to the present embodiment, however, the range without the oscillation motion is set to correspond to the range where the constant surface speed control is performed, and the situation where the oscillation machining is performed beyond the upper limit value can be avoided more reliably.

The spindle override is the function of adjusting the feeding speed and the rotation speed during the cutting using a dial or any other device. If this function causes the index value to exceed the upper limit value, the situation where the oscillation machining is performed beyond the upper limit value can be avoided.

The storage 20 will be described below. The storage 20 stores various types of information for the control and machining of the machine tool. The storage 20 of the present embodiment stores the machining conditions and the oscillation conditions. The machining conditions and the oscillation conditions are inputted as the machining program or specified as parameters for the machine tool by an operator. The storage 20 may not be arranged inside the numerical controller 1, and can be an external component.

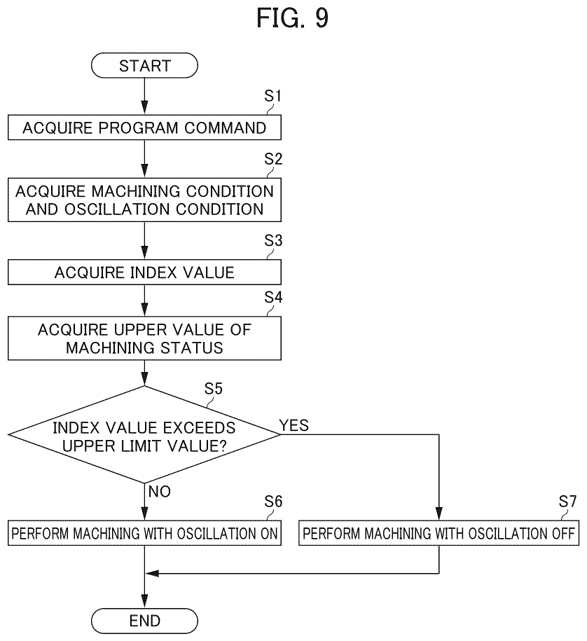

The general configuration of the numerical controller 1 has been described. Next, how an oscillation determination process according to the present embodiment is performed will be described. FIG. 9 is a flowchart illustrating an example of a flow of the oscillation determination process by the numerical controller 1 for the machine tool.

First, the program command acquisition unit 14 acquires a command of the machining program from the storage 20 (Step S1). Then, the condition acquisition unit 11 acquires the machining condition and the oscillation condition based on the machining program and the parameters stored the storage 20 (Step S2). The program command acquisition unit 14 and the condition acquisition unit 11 can acquire information from any target.

After the process of Step S2, the machining status acquisition unit 12 acquires the index values based on the machining condition and the oscillation condition acquired by the condition acquisition unit 11 (Step S3). In the present embodiment, the machining status acquisition unit 12 calculates the chip length, the surface roughness, the oscillation frequency, the oscillation amplitude, the maximum speed, the maximum acceleration, and the maximum jerk as the index values based on the machining condition and the oscillation condition.

After the process of Step S3, the machining upper limit acquisition unit 13 acquires the upper limit values as criteria for determining whether the oscillation machining is performed or not (Step S4). In the present embodiment, the machining upper limit acquisition unit 13 acquires the upper limit values stored as the setting parameters from the storage 20.

After the process of Step S4, the oscillation motion determination unit 15 compares the index values acquired by the machining status acquisition unit 12 and the upper limit values corresponding to the index values (Step S5). If none of the index values exceed the upper limit values (NO is selected in Step S5), the oscillation motion determination unit 15 proceeds the process to Step S6. If any of the index values exceeds the upper limit value (YES is selected in Step S5), the oscillation motion determination unit 15 proceeds the process to Step S7.

In Step S6, none of the index values exceed the upper limit values, and the oscillation motion determination unit 15 determines that the machining is performed with the oscillation ON as instructed by the machining program.

In Step S7, any of the index values exceeds the upper limit value, and the oscillation motion determination unit 15 determines to set the range without the oscillation motion as described above and perform the machining with the oscillation OFF (perform the machining without the oscillation motion).

After the process of Step S6 or S7, the numerical controller 1 performs machining control based on the determination result by the oscillation motion determination unit 15.

The numerical controller 1 for the machine tool according to the first embodiment described above have the following advantages.

The numerical controller 1 for the machine tool of the present embodiment includes: the machining status acquisition unit 12 that acquires the index value indicating the machining status; the machining upper limit acquisition unit 13 that acquires the upper limit value of the index value indicating the machining status; the program command acquisition unit 14 that acquires command information of the machining program 100; and the oscillation motion determination unit 15 that determines whether the oscillation motion of relatively oscillating the cutting tool T and the workpiece is performed based the machining program 100, wherein the oscillation motion determination unit 15 sets a range without oscillation so that the oscillation motion is not performed in part of the machining program 100 subsequent to the point at which the index value exceeds the upper limit value. In this configuration, the oscillation stops when the index value exceeds the upper limit value of the oscillation condition, ensuring the safety of the machine tool. When the oscillation stops, the workpiece is machined under the machining condition recommended for the machine tool, causing no damage to the surface machined. The oscillation machining is performed until the index value in the machining program exceeds the upper limit value. Thus, while the influence of the oscillation machining with the index value beyond the upper limit value on the surface to be machined is reduced, part of the workpiece having no such influence is reliably machined with oscillation. This allows balanced, high-quality oscillation cutting.

In the present embodiment, the machining program 100 includes the machining blocks 101 to 104, and the range without the oscillation is part of the machining block 102 including the point 110 at which the index value exceeds the upper limit value, the part being subsequent to the point 110. This allows the oscillation machining to be performed in the same machining block 102 until the index value exceeds the upper limit value, reducing the range without the oscillation machining as much as possible.

In the present embodiment, of the whole machining program 100 including the machining blocks 101 to 104, the range without the oscillation is a part including and following the part of the machining block 102 subsequent to the point where the index value exceeds the upper limit value. This can avoid a situation in which the workpiece that has been affected by the oscillation machining with the index value beyond the upper limit value is further machined with oscillation, and can avoid the influence on the quality of the finished surface more reliably.

The machining status acquisition unit 12 of the present embodiment acquires, as the index value, one or more of the chip length that is the length of the chip from the workpiece W, the surface roughness of the workpiece W, the oscillation frequency of the relative oscillation of the cutting tool T and the workpiece W, the oscillation amplitude of the relative oscillation of the cutting tool T and the workpiece W, the maximum speed of the relative oscillation of the cutting tool T and the workpiece W, the maximum acceleration of the relative oscillation of the cutting tool T and the workpiece W, and a maximum jerk of the relative oscillation of the cutting tool T and the workpiece W. This allows the machining status acquisition unit 12 to monitor various index values, and the determination of whether the oscillation machining is performed or not can be made with higher accuracy.

The numerical controller 1 of the present embodiment further includes the condition acquisition unit 11 that acquires the machining condition and the oscillation condition. The machining status acquisition unit 12 calculates the index value indicating the machining status based on the machining condition and the oscillation condition acquired by the condition acquisition unit 11. Thus, whether the index value exceeds the upper limit value can be determined based on the machining condition and the oscillation condition before the machining starts, allowing more stable cutting than when the determination is made in the course of the machining.

The first embodiment has been focused on the numerical controller 1 for the machine tool, but the present invention is not limited to the configuration of this embodiment. An embodiment different from the above embodiment will be described below.

### Second Embodiment

A numerical controller 1 of a second embodiment will be described below. The numerical controller 1 of the second embodiment has the same fundamental configuration as that of the first embodiment. The second embodiment sets the range without the oscillation motion by a method different from that of the first embodiment.

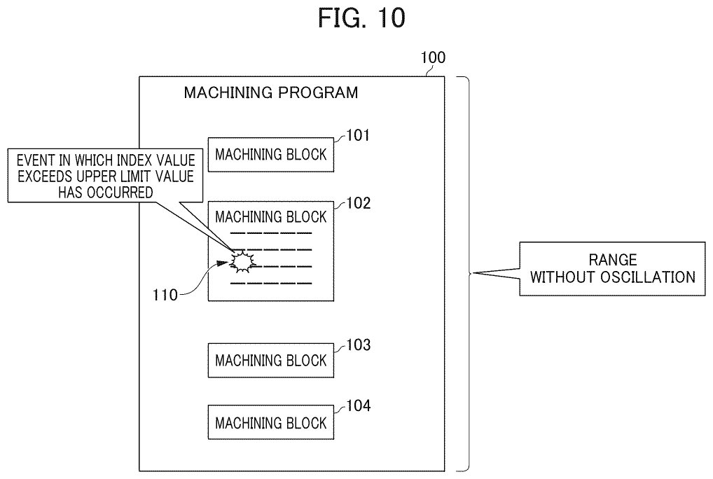

How the range without the oscillation motion is set in the second embodiment will be described below with reference to FIG. 10. FIG. 10 is a view schematically illustrating an example of the range without the oscillation motion determined by an oscillation motion determination unit 15 of the second embodiment.

FIG. 10 schematically shows an example of a machining program 100 including machining blocks 101 to 104. The actual machining is performed in accordance with commands of the machining blocks 101, 102, 103, and 104 in this order. In this example, it is supposed that an event has occurred in which any of the index values in the command of the machining block 102 exceeds the corresponding upper limit value (a point 110 at which the index value exceeds the upper limit value).

In the example of FIG. 10, the whole machining program 100 is set as the range without the oscillation motion if the index value in the machining block 102 exceeds the upper limit value. Thus, no oscillation motion is performed not only in the machining block 102 in which the event has occurred in which the index value exceeds the corresponding upper limit value (the point at which the index value exceeds the upper limit value), but also in the other machining blocks 101, 103, and 104 than the machining block 102.

The numerical controller 1 for the machine tool according to the second embodiment described above have the following advantages.

The numerical controller 1 for the machine tool of the present embodiment includes: the machining status acquisition unit 12 that acquires the index value indicating the machining status; the machining upper limit acquisition unit 13 that acquires the upper limit value of the index value indicating the machining status; the program command acquisition unit 14 that acquires command information of the machining program 100; and the oscillation motion determination unit 15 that determines whether the oscillation motion of relatively oscillating the cutting tool T and the workpiece is performed based the machining program 100, wherein the oscillation motion determination unit 15 sets a range without oscillation so that the oscillation motion is not performed in the whole machining program 100 including a plurality of machining blocks 101 to 104 in a case where there is a point at which the index value exceeds the upper limit value in the machining program 100. In this configuration, the oscillation stops when the index value exceeds the upper limit value of the oscillation condition, ensuring the safety of the oscillation. In addition, the range with the oscillation and the range without the oscillation do not coexist, making the quality of the workpiece less uneven. The oscillation machining is performed not only in the machining block including the point at which the index value exceeds the upper limit value, but also in the whole machining program 100 including the blocks before and after the machining block including the point. Thus, the oscillation machining with the index value beyond the upper limit value can be reliably avoided, and the cutting can be stably performed.

### (Variations)

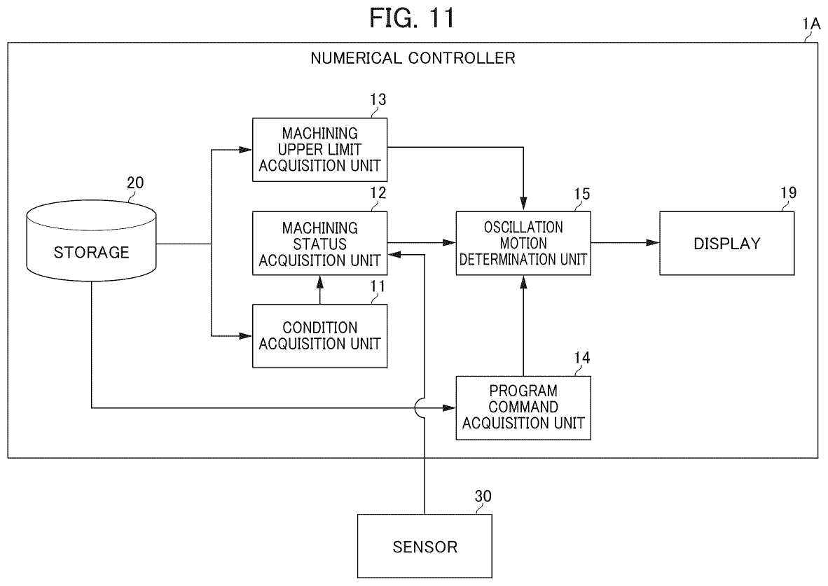

Variations different from the above-described embodiments will be described below. FIG. 11 is a functional block diagram illustrating a numerical controller 1A for a machine tool according to a variation. This variation is the same as the above-described embodiments except that the machining status acquisition unit 12 of the numerical controller 1A acquires the index value indicating the machining status based on a signal from a sensor 30.

The sensor 30 is a device that acquires information indicating the index value directly or indirectly. The sensor 30 may be, for example, a signal acquisition device that acquires a current value and voltage value of a drive unit of a motor, or a contact or non-contact detector that measures the motion of the drive unit such as the motor, the cutting tool T, and the workpiece W itself.

The machining status acquisition unit 12 acquires the index value based on the information acquired from the sensor 30. The machining status acquisition unit 12 may use the index value calculated based on the machining condition and the oscillation condition and the index value based on the information acquired from the sensor 30 in combination. Thus, the method for acquiring the index value is not limited to those described in the first and second embodiments.

The machining status acquisition unit 12 of the numerical controller 1A for the machine tool according to the variation acquires the index value based on the information detected by the sensor 30 that acquires information on the machining status. This allows determination of whether the oscillation is performed or not from the index value based on the actual situation sent from the sensor 30, making the control more suitable for the actual machining.

The present disclosure described in detail is not limited to the above-described embodiments. These embodiments can undergo various additions, replacements, modifications, and partial deletions as long as they do not deviate from the spirit of the present disclosure or from the scope of the claims and their equivalents described herein. These embodiments may be implemented in combination. For example, the order of the operations and the sequence of the processes in the above-described embodiments are presented as examples, and the present disclosure is not limited thereto. The same applies to the numerical values and formulae described in the above-described embodiments.

The following additional remarks related to the embodiments and the variation will be disclosed below.

### (Additional Remark 1)

A control device (1, 1A) for a machine tool that machines a workpiece (W) while relatively oscillating a cutting tool (T) and the workpiece (W), the control device including:
a machining status acquisition unit (12) that acquires an index value indicating a machining status; a machining upper limit acquisition unit (13) that acquires an upper limit value of the index value indicating the machining status;
a program command acquisition unit (14) that acquires command information of a machining program (100); and
an oscillation motion determination unit (15) that determines whether an oscillation motion of relatively oscillating the cutting tool (T) and the workpiece (W) is performed based the machining program (100), wherein
the oscillation motion determination unit (15)
sets a range without oscillation so that the oscillation motion is not performed in part of the machining program (100) subsequent to a point (110) where the index value exceeds the upper limit value.

### (Additional Remark 2)

In the control device (1, 1A) for the machine tool, the machining program (100) includes a plurality of machining blocks (101 to 104), and the range without oscillation is part of one of the machining blocks (104) including the point (110) where the index value exceeds the upper limit value, the part being subsequent to the point (110).

### (Additional Remark 3)

In the control device (1, 1A) for the machine tool, the machining program (100) includes a plurality of machining blocks (101 to 104), and the range without oscillation is part of the whole machining program (100) including and following the part of the machining block (102) subsequent to the point where the index value exceeds the upper limit value.

### (Additional Remark 4)

A control device (1, 1A) for a machine tool that machines a workpiece (W) while relatively oscillating a cutting tool (T) and the workpiece (W), the control device including:
a machining status acquisition unit (12) that acquires an index value indicating a machining status;
a machining upper limit acquisition unit (13) that acquires an upper limit value of the index value indicating the machining status;
a program command acquisition unit (14) that acquires command information of a machining program (100); and
an oscillation motion determination unit (15) that determines whether an oscillation motion of relatively oscillating the cutting tool (T) and the workpiece (W) is performed based the machining program (100), wherein
the oscillation motion determination unit (15)
sets a range without oscillation so that the oscillation motion is not performed in the whole machining program (100) including a plurality of machining blocks (101 to 104) in a case where there is a point (110) where the index value exceeds the upper limit value in the machining program (100).

### (Additional Remark 5)

In the control device (1, 1A) for the machine tool, the machining state acquisition unit (12) acquires the index value based on information detected by a sensor (30) that acquires information on the machining state.

### (Additional Remark 6)

The control device (1, 1A) for the machine tool further includes:
a condition acquisition unit (11) that acquires a machining condition and an oscillation condition, wherein
the machining state acquisition unit (12) calculates the index value indicating the machining state from the machining condition and the oscillation condition acquired by the condition acquisition unit (11).

### (Additional Remark 7)

In the control device (1, 1A) for the machine tool, the machining state acquisition unit (12) acquires, as the index value, one or more of
a chip length that is a length of a chip from the workpiece (W),
a surface roughness of the workpiece (W),
an oscillation frequency of the relative oscillation of the cutting tool (T) and the workpiece (W),
an oscillation amplitude of the relative oscillation of the cutting tool (T) and the workpiece (W),
a maximum speed of the relative oscillation of the cutting tool (T) and the workpiece (W),
a maximum acceleration of the relative oscillation of the cutting tool (T) and the workpiece (W), and
a maximum jerk of the relative oscillation of the cutting tool (T) and the workpiece (W).

### EXPLANATION OF REFERENCE NUMERALS

1, 1A Numerical controller for machine tool (control device for machine tool)
11 Condition acquisition unit
12 Machining status acquisition unit
13 Machining upper limit acquisition unit
14 Program command acquisition unit
15 Oscillation motion determination unit

1. A control device for a machine tool that machines a workpiece while relatively oscillating a cutting tool and the workpiece, the control device comprising:
a machining status acquisition unit that acquires an index value indicating a machining status;
a machining upper limit acquisition unit that acquires an upper limit value of the index value indicating the machining status;
a program command acquisition unit that acquires command information of the machining program; and
an oscillation motion determination unit that determines whether an oscillation motion of relatively oscillating the cutting tool and the workpiece is performed based the machining program, wherein
the oscillation motion determination unit sets a range without oscillation so that the oscillation motion is not performed in part of the machining program subsequent to a point where the index value exceeds the upper limit value.

2. The control device for the machine tool according to claim 1, wherein
the machining program includes a plurality of machining blocks, and the range without oscillation is part of one of the machining blocks including the point where the index value exceeds the upper limit value, the part being subsequent to the point.

3. The control device for the machine tool according to claim 1, wherein
the machining program includes a plurality of machining blocks, and the range without oscillation is part of the whole machining program including and following the part of the machining block subsequent to the point where the index value exceeds the upper limit value.

4. A control device for a machine tool that machines a workpiece while relatively oscillating a cutting tool and the workpiece, the control device comprising:
a machining status acquisition unit that acquires an index value indicating a machining status;
a machining upper limit acquisition unit that acquires an upper limit value of the index value indicating the machining status;
a program command acquisition unit that acquires command information of the machining program; and
an oscillation motion determination unit that determines whether an oscillation motion of relatively oscillating the cutting tool and the workpiece is performed based the machining program, wherein
the oscillation motion determination unit sets a range without oscillation so that the oscillation motion is not performed in the whole machining program including a plurality of machining blocks in a case where there is a point where the index value exceeds the upper limit value in the machining program.

5. The control device for the machine tool according to claim 1, wherein the machining status acquisition unit acquires the index value based on information detected by a sensor that acquires information on the machining status.

6. The control device for the machine tool according to claim 1, further comprising: a condition acquisition unit that acquires a machining condition and an oscillation condition, wherein
the machining status acquisition unit calculates the index value indicating the machining status from the machining condition and the oscillation condition acquired by the condition acquisition unit.

7. The control device for the machine tool according to claim 1, wherein the machining status acquisition unit acquires, as the index value, one or more of
a chip length that is a length of a chip from the workpiece,
a surface roughness of the workpiece,
an oscillation frequency of the relative oscillation of the cutting tool and the workpiece,
an oscillation amplitude of the relative oscillation of the cutting tool and the workpiece,
a maximum speed of the relative oscillation of the cutting tool and the workpiece,
a maximum acceleration of the relative oscillation of the cutting tool and the workpiece, and
a maximum jerk of the relative oscillation of the cutting tool and the workpiece.
